(19) United States
(12) Patent Application Publication
(10) Pub. No.: US 2024/0185482 A1
(43) Pub. Date: Jun. 6, 2024

(54) INFORMATION PROCESSING APPARATUS, INFORMATION PROCESSING METHOD, AND PROGRAM

(71) Applicant: SONY GROUP CORPORATION, TOKYO (JP)

(72) Inventors: HONOKA OZAKI, TOKYO (JP); JUNKI INOUE, TOKYO (JP); KAREN MURATA, TOKYO (JP); KENTARO IDA, TOKYO (JP)

(21) Appl. No.: 18/550,386

(22) PCT Filed: Jan. 6, 2022
(86) PCT No.: PCT/JP2022/000214

§ 371 Date: Sep. 13, 2023

(30) Foreign Application Priority Data
Mar. 25, 2021 (JP) 2021-051434

(51) Int. Cl. G06T 11/00; G06F 3/01

(52) U.S. Cl. CPC G06T 11/001; G06F 3/011

(57) ABSTRACT

To provide an information processing apparatus, an information processing method, and a program that are capable of performing appropriate display in accordance with a situation of a worker. An information processing apparatus according to an embodiment of the present technology includes: a processing unit. The processing unit generates, by using at least one of position information of a work area in a real world and position information of an operating body that performs work on the work area by an operation of a worker or work state information in the work area, a guide image for assisting work of the worker in the work area, the guide image being superimposed and displayed on the work area in the real world or an actual image of the work area.

### TECHNICAL FIELD

The present technology relates to an information processing apparatus, an information processing method, and a program that superimpose and display a virtual object on a real object.

### BACKGROUND ART

When a worker performs work such as drawing and makeup in the real world, for example, he/she can perform the work while referring to a guide describing a drawing method, a makeup method, or the like by displaying the guide on AR glasses or a display. Patent Literature 1 describes a head-mounted display that superimposes and displays a virtual object on a real object.

When superimposing and displaying a virtual object on a real object, the superimposed virtual object obstructs the field of view, which makes it difficult to check the state of the real object behind the virtual object in some cases.

### CITATION LIST

### Patent Literature

Patent Literature 1: Japanese Patent Application Laid-open No. 2016-194744

### DISCLOSURE OF INVENTION

### Technical Problem

In view of the circumstances as described above, it is an object of the present technology to provide an information processing apparatus, an information processing method, and a program that are capable of displaying an appropriate guide image in accordance with a situation of a worker.

### Solution to Problem

In order to achieve the above-mentioned object, an information processing apparatus according to an embodiment of the present technology includes: a processing unit.

The processing unit generates, by using at least one of position information of a work area in a real world and position information of an operating body that performs work on the work area by an operation of a worker or work state information in the work area, a guide image for assisting work of the worker in the work area, the guide image being superimposed and displayed on the work area in the real world or an actual image of the work area.

In accordance with this configuration, a guide image suitable for a work situation of a worker is displayed. The worker can perform work easily and quickly by referring to the guide image.

The processing unit may generate the guide image in further consideration of at least one of state information of the operating body or state information of the worker.

The processing unit may estimate, by using at least one of the position information of the work area and the position information of the operating body or the work state information in the work area, a work situation of the worker and change a display form of the guide image in accordance with a result of the estimation.

The display form of the guide image may include display of a basic guide image indicating an ideal work result to be performed on the work area, display of a modified guide image obtained by modifying the basic guide image, or non-display of the basic guide image and the modified guide image.

The modifying may include at least one of a color change, a transparency change, a line width or line style change, an addition of an auxiliary image, a change to frame line display indicating an outline of the basic guide image, a change to outline display of the basic guide image, a resolution change, or highlighting.

The processing unit may estimate whether the work situation of the worker is before work, during work, or after work and generate the guide image in accordance with a result of the estimation.

The processing unit may further subdivide and estimate the work situation of the worker by using at least one of the position information of the work area and the position information of the operating body, the work state information in the work area, state information of the operating body, or state information of the worker, and generate the guide image in accordance with a result of the estimation.

The processing unit may generate, upon estimating that the work situation of the worker is after work, a guide image reflecting evaluation of an actual work result by the worker.

The guide image reflecting evaluation of the actual work result may be an image in which a different portion between an ideal work result and the actual work result by the worker is highlighted.

The processing unit may generate, in a case where the different portion is an insufficient portion where work by the worker is insufficient for the ideal work result and work is performed on the insufficient portion by the operating body, a display signal for assisting the worker to achieve the ideal work result.

The processing unit may generate, in a case where the work situation of the worker is estimated to be after work and a result of work performed by the worker and an ideal work result match, a display signal for displaying information indicating that the guide image is to be not displayed or the results match.

The processing unit may change, in a case where the work situation of the worker is estimated to be after work and a result of work performed by the worker and an ideal work result do not match, the ideal work result on the basis of a work pattern of the worker or on the basis of content of the result of work performed by the worker.

The operating body may be a part of a body of the worker or an object that can be held by the worker.

An information processing method according to an embodiment of the present technology includes:
acquiring position information of a work area in a real world, position information of an operating body that performs work on the work area by an operation of a worker, and work state information in the work area; and
generating, by using at least one of the position information of the work area and the position information of the operating body or the work state information in the work area, a guide image for assisting work of the worker in the work area, the guide image being superimposed and displayed on the work area in the real world or an actual image of the work area.

A program according to an embodiment of the present technology causes an information processing apparatus to the following steps of:
acquiring position information of a work area in a real world, position information of an operating body that performs work on the work area by an operation of a worker, and work state information in the work area; and
generating, by using at least one of the position information of the work area and the position information of the operating body or the work state information in the work area, a guide image for assisting work of the worker in the work area, the guide image being superimposed and displayed on the work area in the real world or an actual image of the work area.

### BRIEF DESCRIPTION OF DRAWINGS

FIG. 1 is a schematic diagram describing an application example of the present technology.

FIG. 2 is a schematic configuration diagram of an information processing system according to an embodiment of the present technology.

FIG. 3 is a diagram schematically describing a positional relationship between a real object and a virtual object.

FIG. 4 is a basic flow diagram of an information processing method relating to processing of generating a guide image in accordance with a work situation of a worker.

FIG. 5 is a flow diagram of an information processing method relating to generation of a guide image.

FIG. 6 is a diagram describing an example of estimating and classifying the work situation of the worker.

FIG. 7 is a diagram describing an example of estimating and classifying the work situation of the worker.

FIG. 8 is a diagram describing an example of a display form of a guide image in the case of before work.

FIG. 9 is a diagram describing an example of a display form of a guide image in the case of during work.

FIG. 10 is a diagram describing an example of a display form of a guide image in the case of during work.

FIG. 11 is a diagram describing an example of a display form of a guide image after work.

FIG. 12 is a diagram describing an example of a display form of a guide image after work.

FIG. 13 is a diagram showing how work is performed while viewing the guide image after work.

FIG. 14 is a diagram describing an example of changing the guide image using the work result of the worker.

FIG. 15 is a diagram describing an example of changing the guide image using the work result of the worker.

FIG. 16 is a schematic diagram describing an application example of the present technology.

FIG. 17 is a schematic diagram describing an application example of the present technology.

### MODE (S) FOR CARRYING OUT THE INVENTION

Hereinafter, an embodiment according to the present technology will be described with reference to the drawings.

### Brief Description of Present Technology

The present technology can be applied to work assistance in the real world using a guide image that is a virtual object. In the present technology, for example, when a worker draws a picture on a canvas or applies makeup to the face, a guide image describing a drawing method and a makeup method is displayed to the worker. The worker can perform the work such as drawing and makeup by referring to the guide image.

The guide image displayed to the worker is a virtual object. The canvas or face is a work area in the real world in which a worker performs work.

In the present technology, the guide image is displayed in a display form suitable for the work situation of the worker. As a result, the worker can perform the work easily and quickly by referring to the guide image. Hereinafter, drawing on a canvas as a work area will be described below as an example.

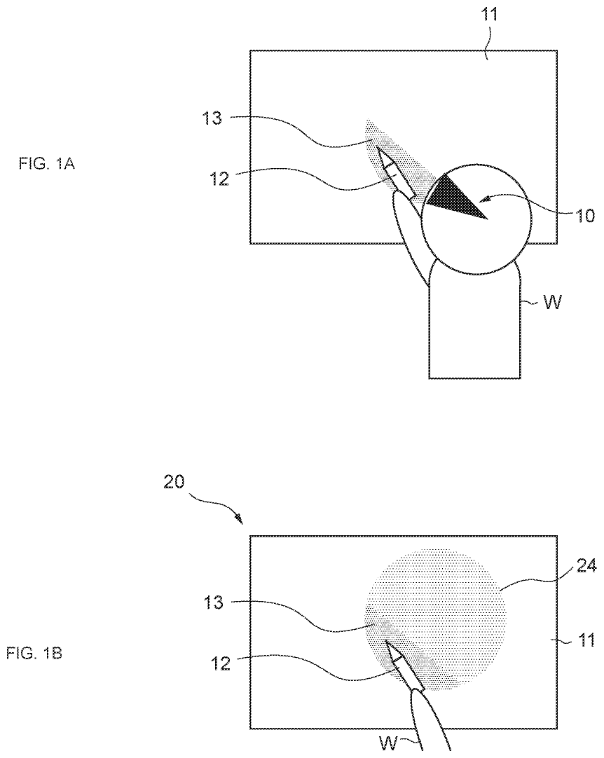

FIG. 1 is a diagram describing an example of work assistance given to a worker W when performing drawing work on a canvas that is a work area 11.

Part (a) of FIG. 1 shows a state where the worker W wearing AR (AR: Augmented Reality) glasses 10 performs drawing work such as coloring on a canvas that is the work area 11 leaned against an easel or the like using an operating body 12 such as a pen and a brush. Display of a guide image by the AR glasses 10 assists the work of the worker.

Note that although AR glasses are taken as an example of the display device used to display a guide image here, the present technology is not limited thereto. Another application example will be described below.

The AR glasses 10 are a glasses-type wearable computer worn on the head of the worker W. The AR glasses 10 are an example of a display device 71 used to display a guide image to a worker. The AR glasses 10 embody an AR technology. The AR technology is a technology for superimposing additional information on the real world and displaying it to the worker. The information displayed to the worker is visualized as, for example, a virtual object in the form of a guide in this embodiment.

The AR glasses 10 include a display positioned in front of the worker's eyes when worn by the worker and display a guide image that is a virtual object in front of the worker's eyes. The guide image is superimposed and displayed on the real world viewed by the worker via the display.

The work area 11 and the operating body 12 are each a real object present in the real world where the worker W is present.

The operating body 12 performs work on the work area 11 by an operation of the worker. In the example shown in FIG. 1, the operating body 12 is, for example, a writing implement such as a pen and a brush. The operating body 12 includes a part of the body of the worker, such as a finger of the worker, in addition to the form that can be held by the worker, such as a writing implement. For example, paint may be applied to the fingertips of the worker to draw on the work area with the fingers, or part of the worker may be used as the operating body.

Part (b) of FIG. 1 shows scenery 20 seen by the worker W through the AR glasses 10.

FIG. 1 shows an example in which the worker W draws a circle with a filled interior on the work area 11 using the operating body 12. This circle with a filled interior is an ideal work result for an information processing system 100 described below. The “ideal work result” can be rephrased as “desired work content”.

As shown in Part (b) of FIG. 1, the worker W recognizes the scenery 20 in which a guide image 24 that is a virtual object has been superimposed on a real object seen through the AR glasses 10. In Part (b) of FIG. 1, the real object seen through the AR glasses 10 includes the work area 11, the operating body 12, a hand of the worker W holding the operating body 12, and an actual work result 13 by the worker W. The actual work result by the worker W is the result of painting work actually performed by the worker W.

In the example shown in FIG. 1, the worker W draws a circle on the work area 11 by referring to the displayed guide image 24. The guide image 24 is a virtual object displayed to the worker in order to assist the drawing work of the worker W.

The worker W can perform the drawing work of the circle with a filled interior easily and quickly by referring to the guide image 24.

In this embodiment, a guide image is displayed with the display form of the guide image 24 set to an appropriate display form in accordance with the work situation of the worker. Details thereof will be described below.

### Schematic Configuration of Information Processing System

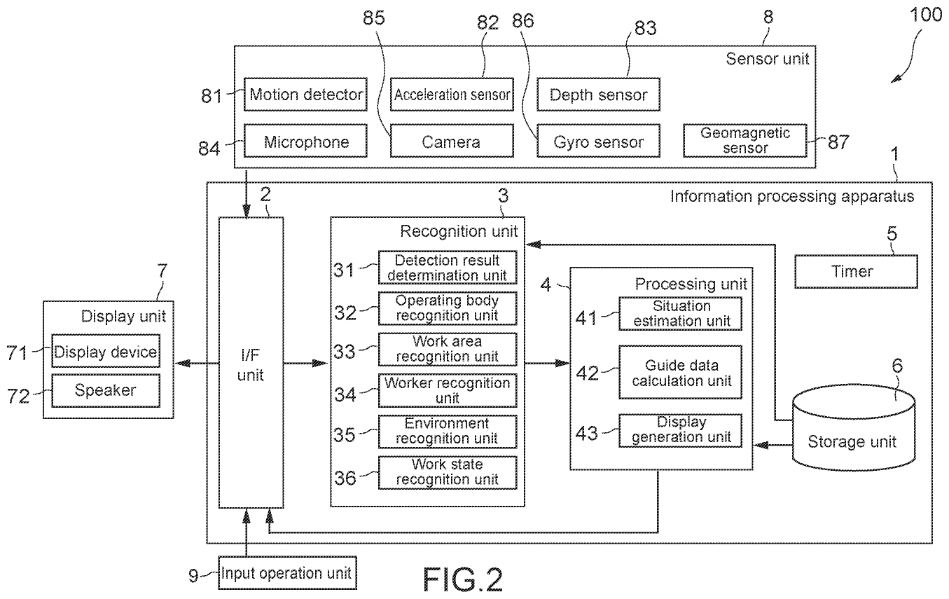

FIG. 2 is a schematic configuration diagram of the information processing system 100 according to an embodiment of the present technology.

As shown in FIG. 2, the information processing system 100 includes an information processing apparatus 1, a sensor unit 8, a display unit 7, and an input operation unit 9.

The sensor unit 8 senses the worker and the surroundings of the worker.

The information processing apparatus 1 estimates the work situation of the worker using the sensing result of the sensor unit 8 and generates the guide image 24 that is a virtual object for assisting the work of the worker in accordance with the work situation. Further, the information processing apparatus 1 may generate guide voice that is auditory assistance in addition to the guide image 24 that is visual assistance.

The display unit 7 displays the guide image 24 that is a superimposition image generated by the information processing apparatus 1 to the worker. Further, the display unit 7 may display the guide voice generated by the information processing apparatus 1 to the worker.

The input operation unit 9 receives an input operation from the worker.

The respective configurations will be described below in detail.

### Sensor Unit

The sensing result of the sensor unit 8 is output to the information processing apparatus 1. A recognition unit 3 of the information processing apparatus 1 described below recognizes worker information, operating body information, work area information, surrounding environment information, work state information in the work area, and the like using the sensing result.

Each piece of information will be described below. The position information indicates three-dimensional position information and coordinates indicate three-dimensional coordinates.

The worker information is information relating to a worker. The worker information includes position information of the worker, state information of the worker, and temporal change information thereof. The position information of the worker includes the coordinates of the position of the worker. The state information of the worker includes posture information of the worker and information regarding the direction of the worker's line of sight, such as the rotation angle and tilt of the worker's head. For example, the orientation of the worker's face and the like can be known from the posture information of the worker.

The operating body information is information relating to an operating body. The operating body information includes position information of the operating body, state information of the operating body, and temporal change information thereof. The position information of the operating body includes the coordinates of the position of the operating body. The state information of the operating body includes posture information of the operating body, such as the orientation, rotation angle, and tilt of the operating body.

The work area information is information relating to a work area. The work area information includes position information of the work area and state information of the work area. The position information of the work area includes the coordinates of the position of the work area. The state information of the work area includes information regarding the content of work performed by the worker on the work area, position information of the work target portion in the work area, and the like.

The surrounding environment information is information relating the surrounding environment of a worker. The surrounding environment information includes the size, brightness, volume of the environmental sound, and the like of the work space where the worker performs work.

The work information in the work area is information regarding the work state according to work by an operating body in a work area. The work state information in the work area includes progress information, a work result, and the like. The progress information indicates to what extent a worker has completed drawing with respect to an ideal work result for the information processing system 100. The work result is the content of the work performed by the worker after finishing work. The information regarding the work result is used to generate a guide image described in a display form example after work described below.

Relative positional relationship information including information regarding the distance between a work area and an operating body can be acquired from the position information of the work area and the position information of the operating body. Relative positional relationship information including information regarding the distance between a work area and a worker can be acquired from the position information of the work area and the position information of the worker.

For example, the sensor unit 8 includes a motion detector 81, an acceleration sensor 82, a depth sensor 83, a microphone 84, a camera 85, a gyro sensor 86, and a geomagnetic sensor 87.

The position information of the work area 11, the position information of the operating body 12, the work state information in the work area, and the like can be acquired using the sensing result of the sensor unit 8. The information processing apparatus 1 estimates the work situation of a worker using these pieces of information and generates a guide image suitable for the work situation of the worker.

For the estimation of the work situation of the worker, at least one of the position information of the operating body 12 and the position information of the work area 11 or the work state information in the work area can be used. Details thereof will be described below.

Note that although it is not necessary to provide all of the sensors listed here, it is possible to perform estimation with higher accuracy by comprehensively using sensing results of a plurality of sensors to estimate the work situation of the worker.

Although each sensor will be described, the arrangement position of each sensor shown below is an example and the present technology is not limited thereto. Each sensor can be appropriately disposed in accordance with the type of display device.

### Motion Detector

The motion detector 81 is disposed, for example, in the vicinity of the work area 11 in the real world. The motion detector 81 senses the presence of a worker located within a predetermined range from the work area 11.

For example, the motion detector 81 can be used as a trigger for activating another sensor, such as activating, in the case where the motion detector 81 has confirmed the presence of a worker, the camera 85 to detect a human or an object.

Further, by using the motion detector 81 and the camera 85 in combination, it is possible to improve the accuracy for human detection.

Further, the motion detector 81 may be used as a trigger for starting processing, such as starting, in the case where the motion detector 81 has confirmed the presence of a worker, work assistance processing in the information processing apparatus described below.

Further, display of a guide image may be turned on (displayed) in the case where the motion detector 81 has confirmed the presence of a worker, and display of a guide image may be turned off (not displayed) in the case where the motion detector 81 has not confirmed the presence of a worker.

### Acceleration Sensor, Gyro Sensor

The acceleration sensor 82 and the gyro sensor 86 are provided to, for example, the operating body 12 configured to be holdable by a worker, the worker's wrist, or the like. By using the sensing results of the acceleration sensor 82 and the gyro sensor 86, it is possible to detect operating body information such as the position and state of the operating body 12.

In the case where the acceleration sensor 82 and the gyro sensor 86 are not mounted on the operating body 12, by providing the acceleration sensor 82 and the gyro sensor 86 to the worker's wrist on the side holding the operating body 12, or the like, it is possible to indirectly detect the position and state of the operating body 12. Further, in the case where a finger of the worker is used as the operating body, by providing the acceleration sensor 82 and the gyro sensor 86 to the wrist on the same side as the finger performing work, or the like, it is possible to indirectly detect the position and state of the finger that is the operating body. The same applies also to the geomagnetic sensor 87 described below.

Further, in the example using the AR glasses 10, the acceleration sensor 82 and the gyro sensor 86 may be mounted on the AR glasses 10. As a result, it is possible to acquire worker information such as the position of the face of the worker wearing the AR glasses 10 and the posture of the worker.

Posture information can be detected by appropriately combining a gyro sensor, an acceleration sensor, an angular acceleration sensor, and the like. An IMU (Inertial Measurement Unit) including a gyro sensor and an acceleration sensor may be used. A sensor combining at least one or more of a 3-axis geomagnetic sensor, a 3-axis acceleration sensor, and a 3-axis gyro sensor may be mounted on AR glasses to detect the front-read, right-left, and up-down movement of the worker's head.

### Depth Sensor

The depth sensor 83 is a sensor that takes a distance image having distance information of a subject. For the depth sensor, for example, a ToF (Time of flight) method can be suitable used. In the ToF depth sensor, near-infrared light (NIR light) is used to acquire a distance image having information regarding the distance between the depth sensor and the subject.

The depth sensor 83 is typically mounted on the AR glasses 10. The depth sensor 83 is provided, for example, in the vicinity of the camera 85 described below. A distance image having information regarding the distance between the work area 11 and the worker W, a distance image having information regarding the distance between the work area 11 and the operating body 12, and the like can be acquired from the sensing result of the depth sensor 83.

The worker information, the operating body information, the work area information, the surrounding environment information, and the like can be acquired from the distance image that is the sensing result acquired by the depth sensor 83. Using these pieces of information, a positional relationship between the work area 11 and the operating body 12 that are real objects in the depth direction seen from the worker can be known.

Note that in addition to the depth sensor 83, a stereo camera may be used to acquire distance information.

### Microphone

The microphone 84 converts the environmental sound that is the voice uttered by a worker the sound generated around the worker into an electrical signal (input audio data).

Using the input audio data that is the sensing result of the microphone, it is possible to sound information such as surrounding environment information of a worker, e.g., the voice uttered by the worker and the environmental sound in a work space.

As the microphone, a known one can be used. One or more microphones selected from an omnidirectional microphone, a unidirectional microphone, and a bidirectional microphone may be used in accordance with the surrounding environment where a worker performs work.

### Camera

The camera 85 is an image sensor that takes a color two-dimensional image (hereinafter, referred to as an RGB image in some cases.) of a subject. The camera 85 is typically mounted on the AR glasses 10. Images of the work area 11, the hand of the worker W who performs work in the vicinity of the work area 11, the operating body 12, and the like, an image of the work space, and the like can be acquired from the sensing result of the camera 85. Note that the number and arrangement positions of the cameras 85 are not limited. For example, in the case where a plurality of cameras 85 is installed, they can be installed at different positions so that the RGB image can be acquired from different angles. For example, in addition to the camera that acquires an image of the front while the AR glasses 10 are worn, a camera that acquires an image of the worker's eyes may be provided to the AR glasses 10. For example, information regarding the direction of the worker's line of sight can be acquired from the image of the worker's eyes.

Using the RGB image that is the sensing result acquired by the camera 85, it is possible to acquire the worker information, the operating body information, the work area information, the surrounding environment information, the work state information in the work area, and the like.

Further, the camera 85 may be disposed in the work space. For example, in the case where posture information of the worker's body is necessary or in the case where the work area 11 is wide and the camera mounted on the AR glasses 10 cannot acquire information of the entire work area, a camera may be installed in the work space so that a bird's-eye image of the work area or the worker can be acquired, in addition to the camera mounted on the AR glasses 10. Note that in the case of using the AR glasses 10 as the display device, a camera is typically provided to the AR glasses. For this reason, a camera does not necessarily need to be installed separately from the AR glasses, but a camera may be installed separately from the AR glasses in the case where the above-mentioned bird's-eye image is necessary, for example.

Note that although an example in which a camera as an image sensor that acquires the RGB image and a depth sensor that acquires a distance image are provided separately from each other has been described here, a camera having both functions of the image sensor and the depth sensor, which is capable of acquiring the RGB image and the distance image, may be used.

### Geomagnetic Sensor

The geomagnetic sensor 87 is a sensor that detects geomagnetism as a voltage value.

The geomagnetic sensor 87 is provided to, for example, the operating body 12 configured to be holdable by a worker or the worker's wrist. Further, in the example of using the AR glasses 10, the geomagnetic sensor 87 may be mounted on the AR glasses 10.

In addition to the gyro sensor and acceleration sensor described above, a geomagnetic sensor may be used to acquire the operating body information, the worker information, and the like.

Further, the geomagnetic sensor 87 may be used for proximity determination.

### Information Processing Apparatus

The information processing apparatus 1 is an information processing terminal for realizing a so-called AR technology and the like. In this embodiment, the information processing apparatus 1 is mounted on, for example, the AR glasses 10 that can be worn by the worker W. Note that the information processing apparatus 1 may be provided separately from the AR glasses 10. In the case of providing them separately, the AR glasses 10 and the information processing apparatus 1 are configured to be capable of communicating with each other wirelessly or by wire.

The information processing apparatus 1 generates the guide image 24 that is a virtual object to be superimposed on the work area 11 in the real world.

As shown in FIG. 2, the information processing apparatus 1 includes an interface unit (I/F unit) 2, the recognition unit 3, a processing unit 4, a timer 5, and a storage unit 6.

### Interface Unit

The interface unit (I/F unit) 2 transmits/receives data to/from various sensors of the sensor unit 8, the display unit 7, and the input operation unit 9.

### Recognition Unit

The recognition unit 3 recognizes the worker information, the operating body information, the work area information, the surrounding environment information, and the work state information in the work area using the sensing results of the various sensors 81 to 87 of the sensor unit 8 received by the I/F unit 2. The information recognized by the recognition unit 3 is output to the processing unit 4.

As shown in FIG. 2, the recognition unit 3 includes a detection result determination unit 31, an operating body recognition unit 32, a work area recognition unit 33, a worker recognition unit 34, an environment recognition unit 35, and a work state recognition unit 36.

### Detection Result Determination Unit

The detection result determination unit 31 determines the type of the detection result and the like using the sensing results detected by the respective sensors of the sensor unit 8.

Specifically, the detection result determination unit 31 executes object detection by performing image analysis and image recognition processing using the RGB image acquired by the camera 85 and the distance image acquired by the depth sensor 83, and determines whether the object (subject) is the worker W, the work area 11, or the operating body 12, or the like. The data necessary for the determination is stored in the storage unit 6 in advance. Further, the recognition result obtained by performing image analysis and image recognition processing may be stored in the storage unit 6 as registration data. By using the registration data when determining the detection result to be performed thereafter, it is possible to improve the determination accuracy. As the method of recognizing an object (subject) from image data such as the RGB image, a known one can be used. As an example, there is an image recognition method using a DNN (Deep Neural Network). The DNN is an algorithm with a multilayer structure modeled on the human brain neural circuit (neural network) designed by machine learning so as to recognize features (patterns) of a subject from image data. The accuracy for determination may be improved by learning features (patterns) each time image recognition processing is performed.

Detection data relating to an object determined to be an operating body by the detection result determination unit 31 is output to the operating body recognition unit 32.

Detection data relating to an object determined to be a work area by the detection result determination unit 31 is output to the work area recognition unit 33.

Detection data relating to an object determined to be a worker by the detection result determination unit 31 is output to the worker recognition unit 34.

### Operating Body Recognition Unit

The operating body recognition unit 32 recognizes operating body information using the detection data output from the detection result determination unit 31. The recognized operating body information is output to the processing unit 4.

Further, in the case where the acceleration sensor 82, the gyro sensor 86, the geomagnetic sensor 87, and the like are mounted on the operating body 12 or worn on the worker's wrist or the like, the operating body recognition unit 32 may recognize the operating body information in further consideration of the sensing results of these sensors. As a result, operating body information with higher accuracy can be obtained.

### Work Area Recognition Unit

The work area recognition unit 33 recognizes work area information using the detection data output from the detection result determination unit 31. The recognized work area information is output to the work state recognition unit 36 and the processing unit 4.

### Worker Recognition Unit

The worker recognition unit 34 recognizes worker information using the detection data output from the detection result determination unit 31. The recognized worker information is output to the processing unit 4.

Further, in the case where the acceleration sensor 82, the gyro sensor 86, the geomagnetic sensor 87, and the like are mounted on the AR glasses 10, the worker recognition unit 34 may recognize the worker information in further consideration of the sensing results of these sensors. As a result, worker information with higher accuracy can be obtained.

Further, in the case where an image of the worker's eyes is acquired by the camera 85, the worker recognition unit 34 may recognize the information regarding the direction of the worker's line of sight (worker information) using the acquired RGB image.

For example, at least one of the right and left eyes is detected from the RGB image by image recognition processing. Further, line-of-sight detection is performed on the basis of the position of the pupil in the eye detected by the image recognition processing. In general, when the eyes are moved unconsciously, the pupils of the right and left eyes show the same behavior. For example, in the case where the face is not moved and the line of sight is directed upward, the pupils of the right and left eyes move upward. Therefore, line-of-sight detection can be performed on the basis of the position of the pupil of one open eye whose eyelid is not closed. In the case where a state where the pupil is in the center of the eye is detected by image recognition, the line of sight is assumed to be in the front direction. In the case where a state where the pupil is on the left side of the eye is detected by image recognition, the light of sight is assumed to be in the left direction. In the case where a state where the pupil is on the right side of the eye is detected by image recognition, the line of sight is assumed to be in the right direction. In the case where a state where the pupil is on the upper side of the eye is detected by image recognition, the line of sight is assumed to be in the upward direction. In the case where a state where the pupil is on the lower side of the eye is detected by image recognition, the line of sight is assumed to be in the downward direction.

The work situation of the worker, such as “the worker has a bird's-eye view of the entire work area” and “the worker is looking at the details of part of the work area”, can be estimated from the information regarding the direction of the worker's line of sight.

### Environment Recognition Unit

The environment recognition unit 35 recognizes surrounding environment information of a worker, such as the size, brightness, volume of the environmental sound, and the like of the work space, using the sensing results detected by the sensors of the sensor unit 8. The recognized surrounding environment information is output to the processing unit 4.

Specifically, the environment recognition unit 35 is capable of recognizing the surrounding environment information such as the size and brightness of the work space using the RGB image acquired by the camera 85, the distance image acquired by the depth sensor, and the like. The environment recognition unit 35 is capable of recognizing environmental sound that is surrounding environment information, and the like using the input audio data acquired by the microphone 84.

For example, in the case where voice display is given to a worker, the volume of the sound emitted from the speaker can be adjusted using surrounding environment information such as the size of the work space and the volume of environmental sound. Further, the display form can be changed, e.g., guide voice is not played in the case where environmental sound is loud.

Further, it is possible to adjust a guide image such that it is easier for the worker to see by changing the color of the guide image using surrounding environment information such as the brightness of the work space.

### Work State Recognition Unit

The work state recognition unit 36 recognizes work state information in the work area 11 using the work area information recognized by the work area recognition unit 33, the operating body information recognized by the operating body recognition unit 32, the worker information recognized by the worker recognition unit 34, and the like. The recognized work state information is output to the processing unit 4.

### Processing Unit

The processing unit 4 generates the guide image 24 to be superimposed on the work area 11 in the real world using the operating body information, worker information, work area information, surrounding environment information, work state information in the work area, and the like recognized by the recognition unit 3. The guide image 24 is virtual object for assisting work of a worker.

In more detail, the processing unit 4 estimates the work situation of a worker using at least one of the position information of the operating body 12 and the position information of the work area 11 or the work state information in the work area 11. The processing unit 4 may estimate the work situation of the worker using, in addition to the position information of the operating body 12 and the position information of the work area 11 and/or the work state information of the work area 11, the operating body information such as the state information of the operating body 12 and the worker information such as the information regarding the direction of the line of sight of the worker W.

Then, the processing unit 4 generates, in accordance with the estimated work situation of the worker, the guide image 24 suitable for the work situation. The display form of the guide image 24 differs depending on the work situation of the worker.

Further, the work situation of the worker and the like estimated by the processing unit 4 may be stored in the storage unit 6 as registration data.

The processing unit 4 includes a situation estimation unit 41, a guide data calculation unit 42, and a display generation unit 43.

### Situation Estimation Unit

The situation estimation unit 41 estimates the current work situation of a worker using at least one of the position information of the operating body and the position information of the work area or the work state information in the work area recognized by the recognition unit 3. The situation estimation unit 41 may estimate the current work situation of the worker using, in addition to the position information of the operating body and the position information of the work area and/or the work state information in the work area, the worker information such as the orientation of the worker's face and the direction of the worker's line of sight and the operating body information such as the irregular movement of the operating body. A specific example of the estimation of the work situation of the worker will be described below.

The estimated work situation of the worker is output to the guide data calculation unit 42.

### Guide Data Calculation Unit

The guide data calculation unit 42 calculates, on the basis of the work situation of the worker estimated by the situation estimation unit 41, a guide form suitable for future display and generated guide data.

### Display Generation Unit

The display generation unit 43 generates an expression for outputting the guide data generated by the guide data calculation unit 42. The display generation unit 43 generates a display signal such as the image signal of the guide image and the audio signal of guide voice. The generated display signal is transmitted to the display device 71.

Specifically, the display generation unit 43 generates, as a visual expression (image signal), the guide image 24 that is a virtual object serving as a superimposition image.

The display generation unit 43 determines the display position of the guide image 24 on the field-of-view area of the worker W in the real world using the position information of the operating body 12 and the position information of the work area output from the recognition unit 3.

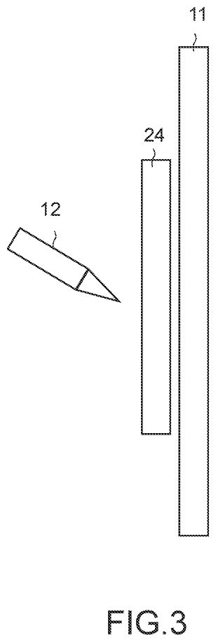

FIG. 3 is a diagram schematically describing a positional relationship between the work area 11 that is a real object and the guide image 24 that is a virtual object. As described above, a positional relationship between the work area 11 and the operating body 12 that are real objects in the depth direction seen from the worker can be known on the basis of the position information of the work area 11 and the position information of the operating body 12 acquired from the distance image acquired by the depth sensor 83. As shown in FIG. 3, the guide image 24 is generated so as to be located between the work area 11 and the operating body 12. In the example shown in FIG. 3, the operating body 12 is present in front of the guide image 24 as seen from the worker. The display generation unit 43 generates, as the guide image 24 to be superimposed on the work area 11 in the real world, the guide image 24 such that the range of a real object that is present in front of the guide image 24 as seen from the worker and overlaps with the guide image 24 is not displayed.

The guide image 24 is generated in the display form according to the work situation of the worker. A specific example of changing the display form of the guide image 24 in accordance with the work situation of the worker will be described below.

Further, the display generation unit 43 may generate an audio expression (audio signal) that is an auditory expression for outputting guide data. By displaying, in addition to the guide image 24, guide voice that is an audio expression to a worker, it is possible to provide more careful work assistance to the worker.

In the following description, a case of generating the guide image 24 that is a visual expression will be mainly described.

### Timer

The timer is used for referring to the time.

### Storage Unit

The storage unit 6 stores a program that causes the information processing apparatus 1 to execute information processing relating to work assistance processing.

The program can installed in the information processing apparatus 1 from a removable recording medium such as a flexible disc, a CD-ROM (Compact Disc Read Only Memory), an MO (Magneto Optical) disc, a DVD (Digital Versatile Disc), a magnetic disc, and a semiconductor memory, or can be downloaded to the information processing apparatus 1 via a wired or wireless transmission medium such as a local area network, the Internet, and digital satellite broadcasting.

The storage unit 6 stores data necessary for image recognition processing.

The storage unit 6 stores information relating to an ideal work result. For example, the arrangement position information of the ideal work result in the work area, information regarding the size, shape, and color of the ideal work result, and the like are stored.

The storage unit 6 stores, as a work history, the operating body information, the work area information, the worker information, and the work state information in the work area recognized by the recognition unit 3 in chronological order. For example, it is possible to estimate work features of a worker, such as the work pattern of the worker, using the work history of the worker.

### Display Unit

The display unit 7 embodies the guide image and audio guide output from the information processing apparatus 1. The guide image and audio guide are for assisting work of a worker. The assistance to the worker only needs to include at least an image guide. By providing an audio guide in addition to the image guide, the worker can perform the work more easily and quickly.

The display unit 7 includes the display device 71 and a speaker 72.

The display device 71 embodies work assistance for a worker by a guide with an image.

The speaker 72 embodies work assistance for a worker by a guide with audio.

The display device 71 converts the image information provided from the information processing apparatus 1 into an image and displays the image. In this embodiment, the AR glasses 10 is an example of the display device 71. Note that although an example of the display device 71 other than AR glasses will be described below, the display device 71 includes, for example, a monitor including a display serving as a display unit or a projector projecting and displaying an image on a wall, a screen, or the like.

In this embodiment, since AR glasses are used as the display device, a guide image is directly superimposed on a work area in the real world, and the work area and the display area are integrated. As a result, the worker can more realistically simulate an ideal work result, for example. Further, it is possible to draw by tracing the guide image displayed in the work area 11 in the real world, which allows more accurate drawing.

The speaker 72 is an audio display device that converts the electrical signal (output audio signal) provided from the information processing apparatus 1 into audio.

As the speaker 72, a known one can be used. For example, one or more speakers selected from an omnidirectional speaker, a unidirectional speaker, and a bidirectional speaker can be used in accordance with the environment where the worker performs work.

### Input Operation Unit

The input operation unit 9 includes, for example, a touch panel, a keyboard, and the like, and receives an operation input to the information processing apparatus 1 by the worker W.

The input operation unit 9 is provided in a device such as a smartphone, a tablet terminal, a smart watch, AR glasses, and a PC, detects a worker's operation, and transmits the detected operation to the information processing apparatus 1. Further, the input operation unit may be provided on a wall, floor, table, door, or the like in the work space.

### Information Processing Method

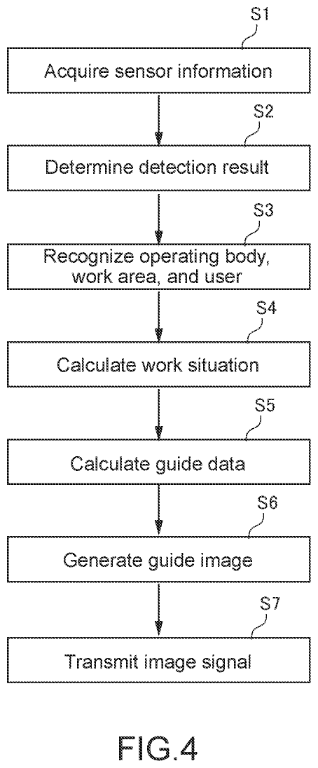

Next, a basic flow of an information processing method relating to work assistance processing in the information processing apparatus 1 will be described with reference to FIG. 4. In this embodiment, the work assistance processing is processing of generating a guide image in accordance with a work situation of a worker.

As shown in FIG. 4, the information processing apparatus 1 acquires a sensing result (sensor information) from the sensor unit 8 (S1).

Next, the detection result determination unit 31 executes object detection using the acquires sensing result to determine the type of object (S2). In the determination, specifically, whether the detection result detected by the object detection is a worker, a work area, or an operating body is determined.

The detection data relating to an object determined to be an operating body by the detection result determination unit 31 is output to the operating body recognition unit 32.

The detection data relating to an object determined to be a work area by the detection result determination unit 31 is output to the work area recognition unit 33.

The detection data relating to an object determined to be a worker by the detection result determination unit 31 is output to the worker recognition unit 34.

Next, using the detection data output from the detection result determination unit 31 and the sensing results of the acceleration sensor 82, the gyro sensor 86, the geomagnetic sensor 87, and the like, the operating body recognition unit 32 recognizes the operating body information, the work area recognition unit 33 recognizes the work area information, and the worker recognition unit 34 recognizes the worker information (S3). Further, the work state recognition unit 36 recognizes the work state information in the work area. The environment recognition unit 35 recognizes the surrounding environment information.

The recognition result recognized by the recognition unit 3 is output to the situation estimation unit 41 of the processing unit 4.

Next, the work situation of the worker is estimated by the situation estimation unit 41 using the recognition result by (S4). The situation estimation unit 41 estimates the current work situation of the worker using at least one of the position information of the operating body and the position information of the work area or the work state information in the work area recognized by the recognition unit 3. The situation estimation unit 41 may estimate the current work situation of the worker in further consideration of the worker information, the operating body information, and the like.

The estimated work situation of the worker is output to the guide data calculation unit 42.

Next, the guide data calculation unit 42 calculates, on the basis of the work situation of the worker estimated by the situation estimation unit 41, guide data of a display form that is optimal for the work situation (S5). The calculated guide data is output to the display generation unit 43.

A display form example of the guide image according to the work situation of the worker will be described below.

Next, the display generation unit 43 generates the guide image 24 to be superimposed on the work area 11 in the real world using the guide data calculated by the guide data calculation unit 42 (S6). The image signal of the generated guide image is transmitted to the AR glasses 10 that are an example of the display device 71 (S7).

The AR glasses 10 convert the image signal provided from the information processing apparatus 1 into an image and display the guide image 24. The worker can perform work quickly by seeing the guide image 24 in a display form suitable for the work situation of the worker.

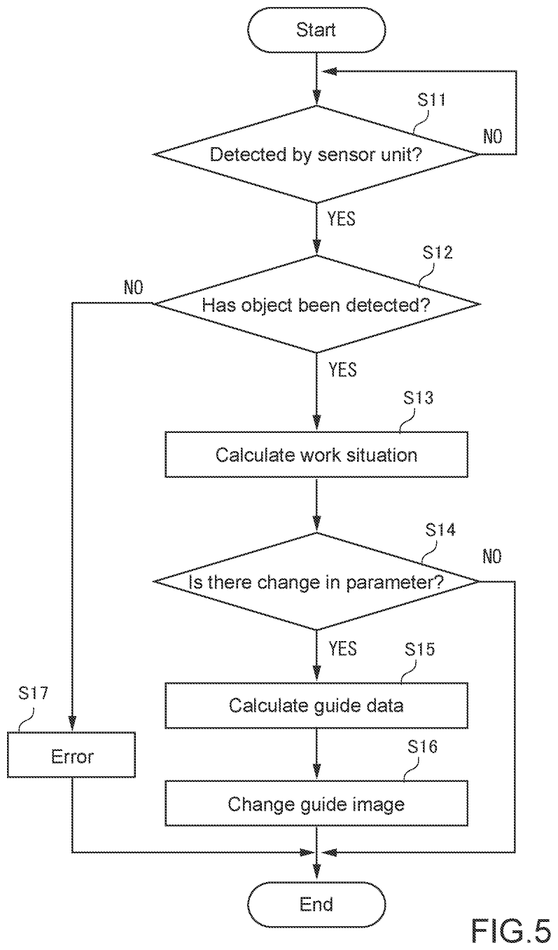

FIG. 5 is a flow diagram of an information processing method relating to generation of a guide image in the information processing apparatus 1.

As shown in FIG. 5, when the processing starts, the information processing apparatus 1 determines, on the basis of the sensing result of the sensor unit 8, which of an operating body, a work area, and a worker has been detected (S11).

When it is determined in S11 that no detection has been made (NO), the processing returns to S11 and the processing is repeated. When it is determined in S11 that detection has been made (YES), which object has been detected is determined (S12).

In the case where it is determined in S12 that no object has been detected (NO), the processing proceeds to S17 and ends with an error.

In the case where it is determined in S12 that an object has been detected (YES), the current work situation of the worker is calculated on the basis of the detection result and the past work history stored in the storage unit 6 (S13).

On the basis of the current work situation of the worker calculated in S13, whether or not it is necessary to change the display form of the guide image 24 is determined. Specifically, in the case where there is no change in the parameter of the display method of the guide image 24, it is determined that it is not necessary to change the display form (NO), and the processing ends. In the case where there is a change in the parameter, it is determined that it is necessary to change the display form (YES), and the processing proceeds to S15.

Next, in S15, guide data is calculated such that a guide image in a display form suitable for the work situation of the worker is obtained.

Next, the guide image 24 whose display form has been changed is generated using the guide data calculated in S15 (S16). The generated image signal of the changed guide image is transmitted to the AR glasses 10 that are an example of the display device 71.

The AR glasses 10 convert the image signal provided from the information processing apparatus 1 into an image and displays the changed guide image 24.

The worker can perform work quickly by seeing the guide image 24 in a display form suitable for the work situation of the worker.

### Example of Estimating Work Situation of Worker

The work situation of the worker can be roughly classified into, for example, “before work”, “during work”, and “after work”.

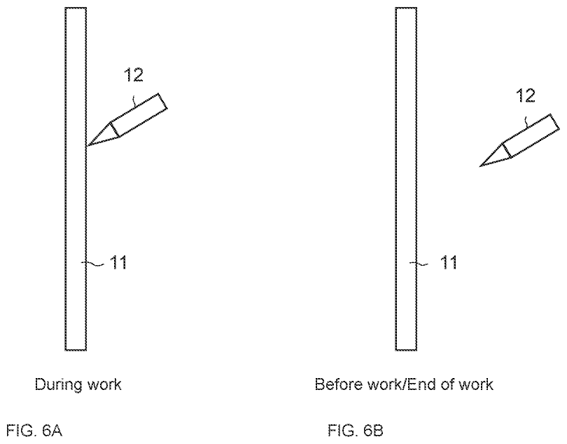

FIG. 6 is a diagram describing an example of estimating the work situation of a worker using the position information of an operating body and the position information of a work area.

As shown in Part (a) of FIG. 6, in the case where the distance between the work area 11 and the operating body 12 is equal to or less than a certain value, it is determined as “during work” in which drawing work is being performed.

As shown in Part (b) of FIG. 6, in the case where the distance between the work area 11 and the operating body 12 exceeds the certain value, it is determined as “before work” or “after work”.

As an example of a method of distinguishing the “before work” and the “after work” from each other, for example, in the case where there is the state of “during work” within a certain period from the estimation of the work situation of the worker, it is determined as the “after work”. Meanwhile, in the case where there is no state of “during work”, it is determined as the “before work”.

As another example of the method of distinguishing the “before work” and the “after work” from each other, they may be distinguished from each other using worker information. Specifically, the time period from when the direction of the worker's line of sight moved to the work target portion in the work area 11 to when work is started is estimated as the “before work”. The time period from the end of work to when the worker's line of sight moves to another portion in the work area 11 is estimated as the “after work”. In this way, the work situation of the worker may be estimated using the worker information in addition to the position information of the operating body and the position information of the work area.

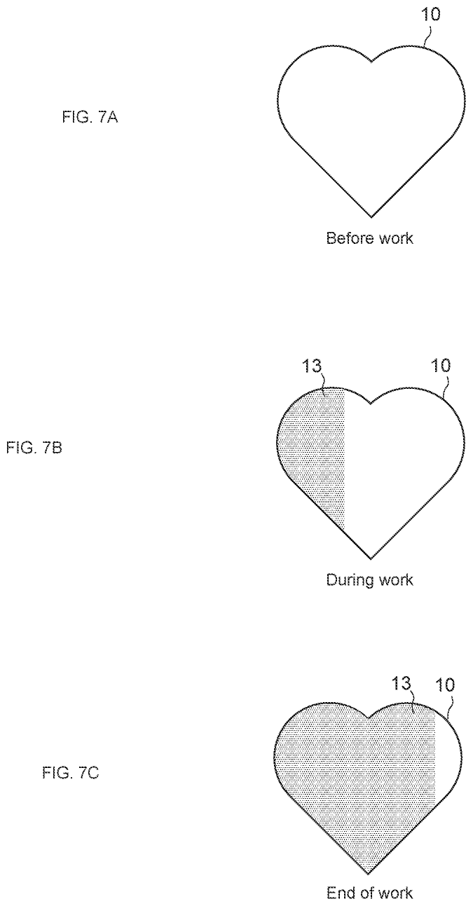

As still another example of the method of distinguishing the “before work” and the “after work” from each other, they may be distinguished from each other using the work state information in the work area. For example, as will be described with reference to FIG. 7, a threshold value is provided for the matching ratio of the actual work result by a worker to the ideal work result of the information processing system 100, and it is determined as the “before work” and the “after work” when the matching ratio is the threshold value or less and when the matching ratio exceeds the threshold value, respectively. In this way, the work situation of the worker may be estimated using the work state information in the work area in addition to the position information of the operating body and the position information of the work area.

These three methods of distinguishing “before work” and the “after work” from each other may each be used alone, or two or more of them may be combined for distinction.

FIG. 7 is an example of classifying the work situation of the worker using the work state information in the work area. In FIG. 7, the ideal work result of the information processing system 100 is filling drawing of a heart with a filled interior. Part (a) of FIG. 7 shows an example of the “before work” state. Part (b) of FIG. 7 shows an example of the “during work” state. Part (c) of FIG. 7 shows an example of the “after work” state.

A threshold value is provided for the matching ratio of the actual work result by a worker to the ideal work result. As shown in Parts (a) and (b) of FIG. 7, in the case where the matching ratio is the threshold value or less, it is determined as the “before work” or “during work”. As shown in Part (c) of FIG. 7, in the case where the matching ratio exceeds the threshold value, it is determined as the “after work (end of work)”.

As an example of the method of distinguishing the “before work” and the “during work” from each other, they may be distinguished from each other using the position information of the operating body and the position information of the work area. For example, in the case where the operating body 12 is not close to the work area 11, i.e., in the case where the distance between the work area 11 and the operating body 12 exceeds a certain value, it is determined as the “before work”. Meanwhile, in the case where the operating body 12 is close to the work area 11, i.e., in the case where the distance between the work area 11 and the operating body 12 is equal to or less than the certain value, it is determined as the “during work”. In this way, the work situation of the worker may be estimated using the position information of the operating body and the position information of the work area in addition to the work state information in the work area.

Further, a first threshold value and a second threshold value larger than the first threshold value may be provided for the matching ratio. Then, in the case where the matching ratio is equal to or less than the first threshold value, it may be estimated as the “before work”. In the case where the matching ratio is larger than the first threshold value and is equal to or less than the second threshold value, it may be estimated as the “during work”. In the case where the matching ratio is larger than the second threshold value, it may be estimated as the “after work”.

The work situation of the worker may be estimated using the method of using the position information of the operating body and the position information of the work area alone, the method of using the state information in the work area alone, or these methods in combination. Estimation using these methods in combination improves the estimation accuracy.

Further, as shown in the example described above, the work situation of the worker may be estimated further using the worker information, the operating body information, and the like in addition to the position information of the operating body and the position information of the work area and/or the work state information in the work area, which can improve estimation accuracy.

Note that the estimation of the work situation of the worker is not limited to the methods described here.

In the following description, an example of estimating the “before work”, “during work”, and “after work” using the work state information in the work area will be described. Note that in the case where the estimation accuracy of “before work”, “during work”, and “after work” is low with only the work state information in the work area, the work situation of the worker can be estimated comprehensively by further using the position information of the operating body, the position information of the work area, the operating body information, the worker information, and the like.

### Display Form Example of Guide Image

A display form example of a guide image according to the work situation of a worker will be described.

As described above, the work situation of the worker can be roughly classified into, for example, “before work”, “during work”, and “after work”. The display form of the guide image can be changed depending on these classifications. Further, the work situation of the worker can be estimated by further subdividing the classification in further consideration of the operating body information and the worker information, and the display form of the guide image can be changed depending on the work situation of the worker.

In this specification, among the guide images, a guide image showing the ideal work result of the information processing system 100 will be referred to as a basic guide image 241. A guide image obtained by modifying the basic guide image 241 will be referred to as a modified guide image 242. The basic guide image 241 and the modified guide image 242 will each be referred to as the guide image 24 when there is particularly no need to distinguish them from each other.

The change in display form of a guide image includes a change from a basic guide image to a modified guide image, a change from a modified guide image to a basic guide image, a change from display of a basic or modified guide image to non-display, non-display of a basic or modified guide image to display, and the like. The change from display of a basic or modified guide image to non-display and the change from non-display of a basic or modified guide image to display can be said to be control of the display time of the guide image and the non-display time of the guide image.

The modification includes a color change, a line width or line style change, a transparency change, an addition of an auxiliary image, displaying a basic guide image with a frame line, displaying a basic guide image with an outline display, displaying part of a basic guide image, changing a display resolution, highlighting, and the like. One of these modification methods may be used or two or more of these modification methods may be used in combination to generate a modified guide image.

Note that when a guide image is generated as a superimposition image, the guide image is generated such that the guide image is not displayed for the portion where a real object located in front of the guide image as seen from a worker overlaps. The modification does not include making part of the guide image being not displayed for such superimposition processing.

The color change can be performed by changing at least one of the hue, saturation, or brightness of the color. For example, in the case where the guide image is difficult to see because the color of the work area and the color of the ideal work result are similar colors, for example, the color of the guide image may be changed. Further, for example, in the case where the surrounding environment is too bright and it is difficult to see with the color of the basic guide image, the color of the guide image may be changed. In this way, the color of the guide image may be changed on the basis of at least one of the work area information or the surrounding environment information.

The transparency change described above can be performed by adjusting the alpha value representing the transparency of the guide image. The alpha value is information regarding transparency set for each pixel in digital image data. The alpha value takes an integer value ranging from, for example, 0 to 255. When the alpha value of a pixel is zero, the pixel of the guide image 24 is completely transparent and the work area 11 located on the far side of the guide image 24 as seen from the worker wearing the AR glasses 10 looks completely transparent. When the alpha value is approximately 128, the image of the guide image is translucent. When the alpha value is 255, the pixel of the guide image 24 is completely opaque.

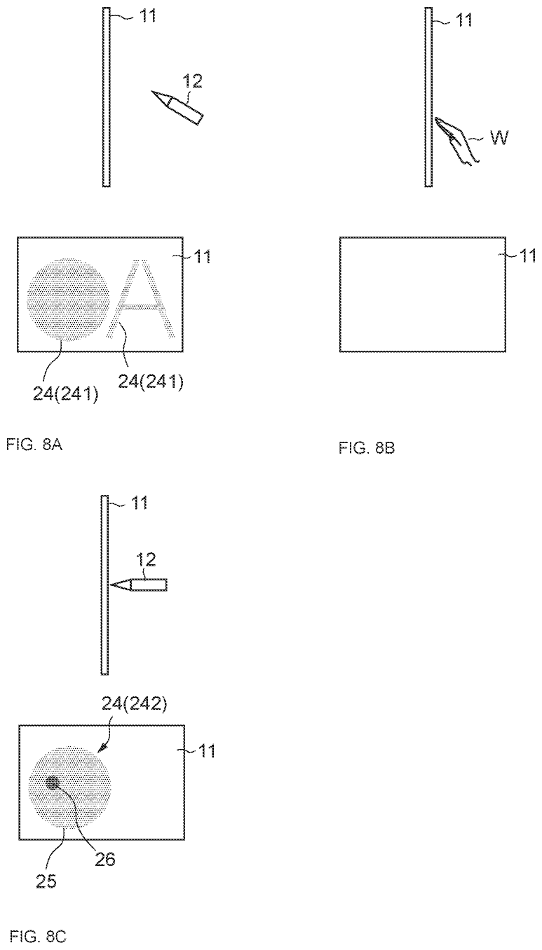

As an example of the auxiliary image described above, there is a dot-like auxiliary image indicating the tip portion of the operating body as shown in Part (c) of FIG. 8 described below. Another example of the auxiliary image is an auxiliary image of characters. For example, in the case where the guide image is difficult to see because the color of the ideal work result is similar to the color of the work area, for example, the difficulty of seeing the color of the real object may be complemented by characters. Note that the tip of the operating body is a portion of the operating body that actually performs work on the work area during drawing work. For example, it is the tip pin in the case where the operating body is a pen and it is the brush tip in the case where the operating body is a writing brush.

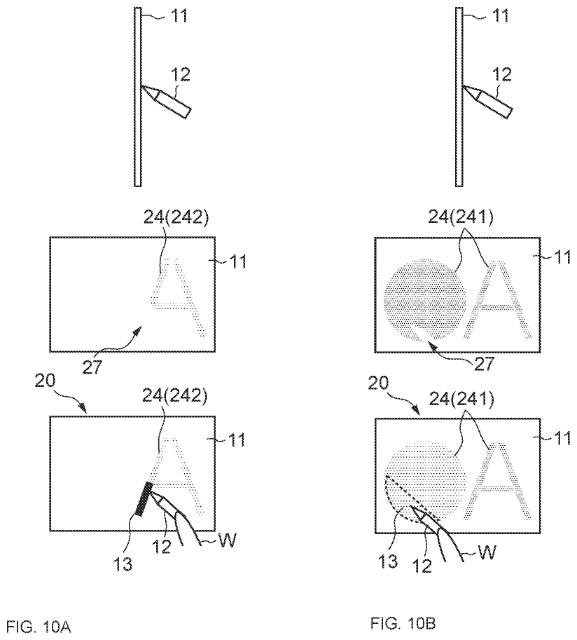

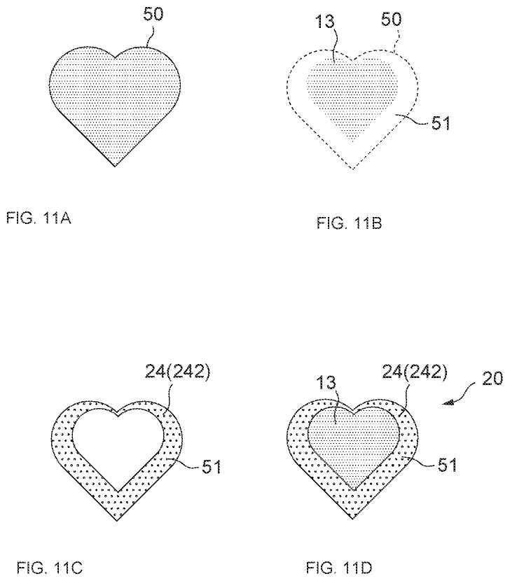

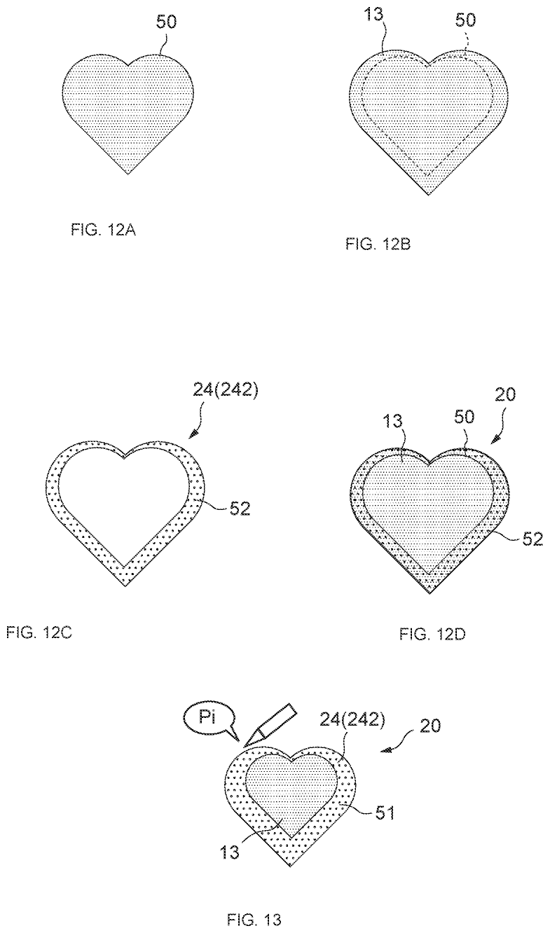

As an example of the highlighting described above, there is highlighting of a different portion between the ideal work result that is a basic guide image and the work result actually performed by the worker W. The highlighting is display that allows the worker to visually recognize where the different portion is. Examples of the highlighting includes displaying a different portion in a color different from that of the surroundings of the different portion, and displaying with a frame line tracing the outline of the different portion. The method of highlighting can be appropriately determined in accordance with the state of the work area and the work content. A specific example of the highlighting will be described below with reference to FIG. 11 and FIG. 12.

A specific example will be described below.

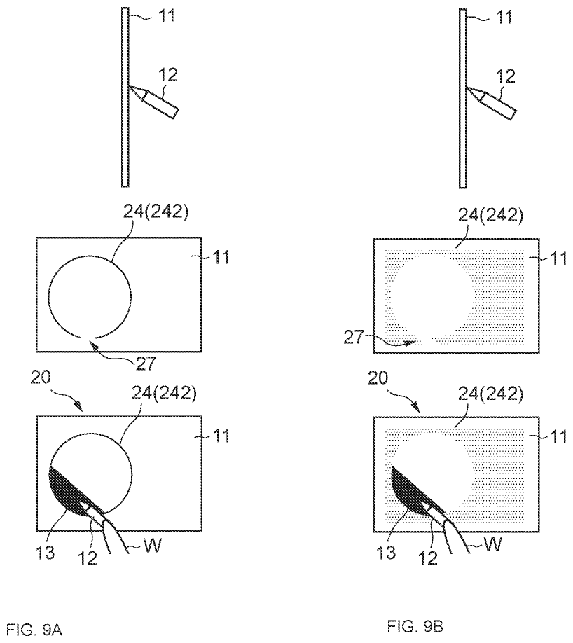

FIG. 8 and FIG. 9 show an example in which the ideal work result of the information processing system 100 is drawing of a circle with a filled interior and drawing of the letter A. The drawing of the circle with a filled interior is an example of filling drawing. The drawing of the letter A is an example of line drawing.

### Display Form Example Before Work

Parts (a) to (c) of FIG. 8 show a display form example of a guide of the “before work” in which drawing work has not been performed on the work area yet. In each of Parts (a) to (c) of FIG. 8, the diagram located on the upper side is a schematic diagram of the work area 11 in the real world viewed from the side, and the diagram located on the lower side shows the guide image 24 displayed by the AR glasses 10.

In the case where nothing has been drawn in the work area 11 in the real world, the matching ratio is equal to or less than the first threshold value, and thus, the “before work” is estimated using the work state information in the work area 11 as described above.

As shown in Part (a) of FIG. 8, in the case where the operating body 12 is not facing the direction of the work area 11 or the operating body 12 is moving irregularly, it is estimated that the work situation of the worker is not immediately before drawing work. In this way, it is possible to classify the situation of the worker “before work” in more detail in consideration of the operating body information.

In the case where the work situation of the worker is the “before work” and it is estimated that the work situation of the worker is not immediately before drawing work, the entire guide is displayed in a bird's-eye view and the basic guide image 241 is displayed in the example shown in Part (a) of FIG. 8.

The worker recognizes the scenery in which the basic guide image 241 has been superimposed on the work area 11 in the real world through the AR glasses 10. The worker can grasp the entire image of the work content in the work area 11 from the scenery and can intuitively grasp what state the work area 11 will be in after the work is completed.

As shown in Part (b) of FIG. 8, in the case where the hand of the worker W is touching the work area 11, it is estimated that the work situation of the worker is estimated is the situation of checking the state of the work area 11, such as whether the surface of the work area 11 provides a rough haptic sensation. In this way, the situation of the worker “before work” can be classified in more detail in consideration of the worker information.

In the case where the work situation of the worker is the “before work” and it is estimated that the work situation is the situation of checking the state of the work area 11, the display of the guide image 24 is erased for a short time in the example shown in Part (b) of FIG. 8. As a result, the worker can check the state of the work area 11 without being obstructed by the guide image 24.

Further, in the case where the hand of the worker W is close to the work area 11 and is moving so as to trace the guide image 24, it may be estimated that the work situation of the worker is the situation of simulating drawing. In this way, the situation of the worker “before work” can be classified in more detail in consideration of the worker information.

In the case where the work situation of the worker is the “before work” and it is estimated that the work situation is the situation of simulating drawing, the basic guide image 241 as shown in Part (a) of FIG. 8 may be displayed. As a result, the worker W can simulate the drawing work by referring to the basic guide image 241 to move the hand so as to trace the guide image. At this time, for example, a modified guide image whose color has been changed to a color that is easy for the worker to visually recognize on the basis of the color of the work area and the brightness of the work space in consideration of the work area information and the surrounding environment information may be displayed.

When the worker performs work of tracing a line, he/she tends to hold the operating body 12 upright so that the line at hand can be clearly seen in the case where he/she wants to draw a line carefully in accordance with the guide image. Similarly, when the worker performs filling work, he/she tends to hold the operating body 12 upright so that his/her hand can be clearly seen in the case where he/she wants to perform the filling work carefully.

As shown in Part (c) of FIG. 8, in the case where the operating body 12 is stopped in the substantially perpendicular posture with respect to the work area 11, it is estimated that the work situation of the worker is the situation of performing careful work. In this way, the situation of the worker “before work” can be classified in more detail in consideration of the operating body information.

In the case where the work situation of the worker is the “before work” and it is estimated that the work situation is the situation of performing careful work, a result drawn when the operating body 12 is brought into contact with the work area 11 is displayed as the guide image 24 in the example shown in Part (c) of FIG. 8. In the example shown in Part (c) of FIG. 8, the modified guide image 242 in which a dot-like auxiliary image 26 indicating the tip portion of the operating body 12 is located on a circle 25 that is the result to be drawn is displayed. The worker can simulate the work result by looking at the modified guide image 242. Further, the worker can clearly grasp the tip position of the operating body 12 in the work target portion in the work area 11 by looking at the auxiliary image 26 in the modified guide image 242.

Further, the display form of the guide image may be changed depending on information regarding the direction of the worker's line of sight (worker information). For example, when the worker's line of sight frequently moves, it is estimated that the work situation is the situation of grasping the entire image and the entire guide image is displayed. Meanwhile, in the case where the position of the worker's line of sight is stopped, it is estimated that the work situation is the situation of checking part of the work area and the display resolution of the guide image to be superimposed may be increased in accordance with the part of the work area. Further, part of the guide image may be displayed, or only the guide image corresponding to part of the work area in the direction of the worker's line of sight may be displayed.

For example, in the case where it is estimated that the work situation of the worker is the situation of grasping the entire image, a circle and the letter A are displayed as the guide image 24 and the entire guide image is displayed as shown in Part (a) of FIG. 8. Meanwhile, in the case where it is estimated that the work situation is the situation in which the worker checks part of the work area, e.g., the left side of the work area, the display resolution of only the guide image of the circle, of the basic guide image, is increased for display. By partially increasing the resolution in this way, it is possible to suppress the processing load. Alternatively, part of the guide image may be displayed, e.g., only the guide image of the circle is displayed without displaying the guide image of the letter A.

In this way, the situation of the worker may be estimated in further consideration of the worker information, and the display form of the guide image may be changed on the basis of the estimation result.

### Display Form Example During Work

Parts (a) and (b) of FIG. 9 and Parts (a) and (b) of FIG. 10 each show a display form example of the guide image of the “during work” while drawing work is being performed on the work area. In each diagram of Parts (a) and (b) of FIG. 9 and Parts (a) and (b) of FIG. 10, the diagram located on the upper side is a schematic diagram of the work area 11 in the real world viewed from the side. The diagram located in the center is a diagram of the guide image 24 displayed by the AR glasses 10 corresponding to the work area 11. The diagram located on the lower side shows the scenery 20 recognized by the worker W through the AR glasses 10.

As described above, when the matching ratio is larger than the first threshold value and is equal to or less than the second threshold value, it is estimated as the “during work” using the work state information in the work area 11.

Here, during work, the operating body or the body of the worker himself/herself tends to overlap with the guide image, and it tends to be difficult to see the state of the work area 11 near the hand of the worker holding the operating body.

Parts (a) and (b) of FIG. 9 show the situation in which the worker W performs work of filling drawing.

As shown in Parts (a) and (b) of FIG. 9, in the case where the tip of the operating body 12 is reciprocating within a partial area of the work area 11 while being in contact with the work area 11, it is estimated that the work situation of the worker is the situation of performing filling work. In this way, the situation of the worker “during work” can be classified in more detail in consideration of the operating body information.

In the case where the work situation of the worker is the “during work” and it is estimated that the filling work is being performed, the modified guide image 242 in which the outline of the basic guide image is displayed with a frame line is generated and displayed as a guide image as shown in the diagram located in the center of Part (a) of FIG. 9. The modified guide image 242 is generated such that the guide image is not displayed for a portion 27 of the modified guide image 242 where the operating body 12 located in front of the modified guide image 242 as seen from the worker overlaps. In the example of the diagram located in the center of Part (a) of FIG. 9, the modified guide image 242 has a shape in which part of the circle overlapping with the operating body 12 is missing.

As shown in the diagram located on the lower side of Part (a) of FIG. 9, the worker W recognizes, through the AR glasses 10, the scenery 20 in which the modified guide image 242 has been superimposed on the field-of-view area in the real world including the work area 11, the operating body 12, and the hand of the worker W that are real objects, and the actual work result 13.

By displaying with a frame line, the worker W wearing the AR glasses 10 can grasp the position of the portion to be filled. Further, since the portion to be filled is not blocked by the modified guide image 242, the worker W can perform filling work while checking the state of the work target portion of the work area 11 in the real world. In this way, the worker can perform desired work easily and quickly by referring to the modified guide image 242 even during work in which the state of the work area 11 tends to be difficult to see.

Alternatively, in the case where the work situation of the worker is the “during work” and it is estimated that the filling work is being performed, the modified guide image 242 in which the basic guide image is displayed with an outline may be generated and displayed as a guide image as shown in the diagram located in the center of Part (b) of FIG. 9. The modified guide image 242 is generated such that the guide image is not displayed for the portion 27 of the modified guide image 242 where the operating body 12 located in front of the modified guide image 242 as seen from the worker overlaps.

As shown in the diagram located on the lower side of Part (b) of FIG. 9, the worker W recognizes, through the AR glasses 10, the scenery 20 in which the modified guide image 242 has been superimposed on the field-of-view area in the real world including the work area 11, the operating body 12, and the hand of the worker W that are real objects, and the actual work result 13.

By displaying with an outline, the worker W wearing the AR glasses 10 can grasp the position of the portion to be filled. Further, since the portion to be filled is not blocked by the modified guide image 242, the worker W can perform filling work while checking the state of the work target portion of the work area 11 in the real world. In this way, the worker W can perform desired work easily and quickly by referring to the guide image even during work in which the state of the work area 11 tends to be difficult to see.

Part (a) of FIG. 10 shows the situation in which a worker is performing work of line drawing of the letter A.

As shown in Part (a) of FIG. 10, in the case where the tip of the operating body 12 is moving mainly along one direction within a partial area within the work area 11 while being in contact with the work area 11, it is estimated that the work situation of the worker is the situation of performing work of line drawing. In this way, the situation of the worker “during work” can be classified in more detail in consideration of the operating body information.

In the case where the work situation of the worker is the “during work” and it is estimated that work of line drawing is being performed, the modified guide image 242 of the letter A in which the shape of the line of the basic guide image is not changed and the transmittance is changed to be lower than that of the basic guide image is generated and displayed as a guide image as shown in the diagram located in the center of Part (a) of FIG. 10. The modified guide image 242 is generated such that the guide image is not displayed for the portion 27 of the modified guide image 242 where the operating body 12 located in front of the modified guide image 242 as seen from the worker overlaps.

As shown in the diagram located on the lower side of Part (a) of FIG. 10, the worker W recognizes, through the AR glasses 10, the scenery 20 in which the modified guide image 242 has been superimposed on the field-of-view area in the real world including the work area 11, the operating body 12, and the hand of the worker W that are real objects, and the actual work result 13.

Since line drawing requires fine work, the hand of the worker W can be easily seen by changing the transmittance to display the modified guide image 242 so that it can be seen through. That is, the transparent modified guide image 242 allows the worker W to check the state of the work area 11 located on the far side of the modified guide image 242 through the transparent modified guide image 242. The worker W can perform work of line drawing while checking the state of the work target portion of the work area 11 in the real world. Further, since the difference between the actual work result 13 and the modified guide image 242 is visually clear, the worker W can intuitively grasp the progress of the work and clearly recognize where the portion that has not been drawn yet is. In this way, the worker W can perform desired work easily and quickly by referring to the guide image even during work in which the state of the work area 11 tends to be difficult to see.

Note that although an example of displaying the modified guide image 242 whose transmittance has been changed has been given here, the present technology is not limited thereto. For example, the modified guide image 242 obtained by changing the color of the basic guide image may be displayed. Further, the modified guide image 242 obtained by changing the line width and the line style of the basic guide image may be displayed. As a result, the worker clearly recognizes the difference between the portion where line drawing has been actually performed and the portion where line drawing is to be performed, and it is possible to intuitively grasp the progress of the work and clearly recognize where the portion that has not been drawn yet is.

Part (b) of FIG. 10 shows the situation in which the worker has stopped the work.

As shown in Part (b) of FIG. 10, in the case where the tip of the operating body 12 is in contact with the work area 11 and the movement is stopped, it is estimated that the work situation of the worker is the situation of checking the entire image of the work. In this way, the situation of the worker “during work” can be classified in more detail by further using the operating body information.

In the case where the work situation of the worker is the “during work” and it is estimated that the work situation is the situation of checking the entire image of the work, the basic guide image 241 in which the entire guide is displayed in a bird's eye view is displayed for a short time as shown in the diagram located in the center of Part (b) of FIG. 10. The basic guide image 241 is generated such that the guide image is not displayed for the portion 27 of the basic guide image 241 where the operating body 12 located in front of the basic guide image 241 as seen from the worker overlaps.

As shown in the diagram located on the lower side of Part (b) of FIG. 10, the worker W recognizes, through the AR glasses 10, the scenery 20 in which the basic guide image 241 has been superimposed on the field-of-view area in the real world including the work area 11, the operating body 12, and the hand of the worker W that are real objects, and the actual work result 13. Since the basic guide image 241 is the ideal work result and the worker performs the work by referring to the basic guide image 241, the color of the actual work result 13 and the color of the basic guide image 241 are the same. Therefore, the portion of the actual work result 13 is not clear in the scenery 20 recognized by the worker through the AR glasses 10, and thus, the actual work result 13 is illustrated to be surrounded by a broken line for the sake of convenience in the diagram located on the lower side of Part (b) of FIG. 10.

The worker W can check, through the AR glasses 10, the entire image of the work content in the work area 11 by looking at the scenery 20 on which the basic guide image 241 has been superimposed.

### Display Form Example After Work

After the work is completed, the work area may be detected and analyzed using information regarding the work result performed by the worker (work state information in the work area), and the evaluation of the work result performed by the worker may be displayed as a guide image. As a result, it is possible to display the work result that the worker himself/herself could not have noticed to the worker. For example, in the case of filing work, the worker can grasp that there is an unpainted portion and a paint protruding portion that he/she has not noticed in the work result by looking at the guide image.

FIG. 11 and FIG. 12 are each a diagram for describing the case of displaying the evaluation of the work result of the worker as a guide image.

In each of the diagrams of FIG. 11 and FIG. 12, Part (a) shows an ideal work result 50. Here, the ideal work result 50 is a heart with a filled interior. In the AR glasses 10, the ideal work result 50 can be displayed as the basic guide image 241. Part (b) shows the actual work result 13 performed by the worker and shows the outline of the heart that is the ideal work result 50 by a broken line. Part (c) shows the modified guide image 242 highlighting the different portion between the ideal work result and the actual work result 13 performed by the worker. Part (d) shows the scenery 20 on which the modified guide image 242 has been superimposed, which is recognized by the worker through the AR glasses 10.

As described above, using the work state information in the work area 11, it is estimated that the work situation is the “after work” because the matching ratio is larger than the second threshold value. Note that even in the case where the matching ratio is larger than the first threshold value and is equal to or less than the second threshold value and the “during work” is estimated, it can be comprehensively estimated that the work situation is the “after work” using other pieces of information such as the operating body information, the work area information, and the worker information in combination.

FIG. 11 is a diagram describing an example of the case where the work result indicates that there is an unpainted portion.

As shown in Parts (a) and (b) of FIG. 11, in the case where the work situation of the worker is the “after work” and the actual work result 13 performed by the worker is in the situation in which it is estimated that there is an insufficient portion, i.e., an unpainted portion 51, in view of the ideal work result, the modified guide image 242 in which the unpainted portion 51 is highlighted is generated and displayed as shown in Part (c) of FIG. 11. The modified guide image 242 may be used as a guide for approaching the ideal work result.

As shown in Part (d) of FIG. 11, the worker wearing the AR glasses 10 recognizes the scenery 20 in which the modified guide image 242 including the highlighted unpainted portion 51 has been superimposed on the actual work result 13 actually drawn by the worker in the work area 11 in the real world. The worker can grasp where the position of the unpainted portion 51 is located with respect to the actual work result 13 by looking at the scenery 20.

FIG. 12 is a diagram describing an example of the case where the work result indicates that there is a paint protruding portion.

As shown in Parts (a) and (b) of FIG. 12, in the case where the work situation of the worker is the “after work” and it is estimated that the actual work result 13 performed by the worker is in the situation in which there is a surplus portion, i.e., a protruding potion 52, from the ideal work result, the modified guide image 242 in which the protruding potion 52 is highlighted is generated and displayed as shown in Part (c) of FIG. 12.

As shown in Part (d) of FIG. 12, the worker wearing the AR glasses 10 recognizes the scenery 20 in which the modified guide image 242 including the highlighted protruding potion 52 has been superimposed on the actual work result 13 actually drawn by the worker in the work area 11 in the real world. The worker can grasp where the position of the protruding potion 52 is located with respect to the actual work result 13 by looking at the scenery 20.

As described with reference to FIG. 11 and FIG. 12, by further using the work result (work information in the work area), the work situation of the worker “after work” can be classified in more detail and a more appropriate guide image according to the work situation of the worker can be displayed.

FIG. 13 shows the scenery 20 seen by the worker wearing the AR glasses 10 when he/she is performing filling work while seeing the modified guide image 242 in which the unpainted portion 51 is highlighted shown in Part (c) of FIG. 11.

When it is recognized that the worker is painting or about to paint beyond the unpainted portion 51, a warning of paint protruding may be given by voice display of the speaker 72. The warning by voice display is a display signal for assisting the work to achieve the ideal work result. The situation in which the worker is painting or about to paint beyond the unpainted portion 51 can be estimated on the basis of the position information of the work area, the position information the operating body, and the like obtained using the sensing results of the sensor unit 8.

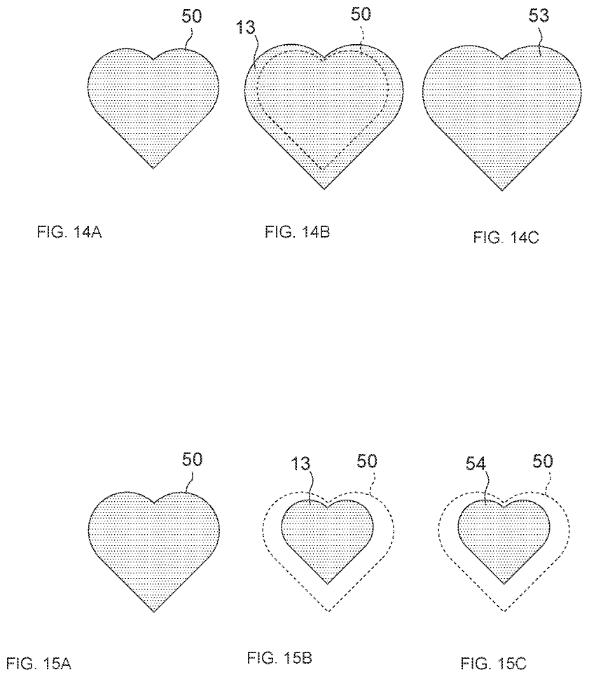

FIG. 14 is a diagram describing an example of the case where the work result indicates that there is a paint protruding portion.

Part (a) of FIG. 14 shows the ideal work result 50. Here, the ideal work result 50 is a heart with a filled interior. Part (b) of FIG. 14 shows the actual work result 13 performed by a worker and shows the outline of the heart that is the work result 50 by a broken line. Part (c) of FIG. 14 shows an ideal work result 53 after the ideal work result is changed.

As shown in Parts (a) and (b) of FIG. 14, for example, in the case where the actual work result 13 performed by the worker protrudes from the ideal work result 50 and cannot be easily corrected, the ideal work result may be changed to the ideal work result 53 by making the shape of the ideal work result slightly larger in accordance with the size of the protrusion as shown in Part (c) of FIG. 14.

In this way, the ideal work result may be changed on the basis of the content of the work result performed by the worker.

A method of determining whether to display a guide image indicating evaluation of the work result actually performed by the worker will be described.

Whether to display, as a guide image, evaluation of the work result actually performed by the worker is determined by whether or not the colors, shapes, and the like of the ideal work result of the information processing system 100 and the work result performed by the worker completely match.

In the case where they match, a guide image is not displayed. Alternatively, information indicating that the work according to the guide has been accomplished, i.e., they match, may be displayed as an image, sound, or the like such that the worker can recognize it.

In the case where they do not match, for example, the modified guide image 242 for approaching the ideal work result as shown in Part (c) of FIG. 11 described above is displayed. The modified guide image assists the worker to achieve the ideal work result.

In the case where the ideal work result and the actual work result of the worker are different from each other, the target work may be regarded as being achieved when the ideal work result of the worker and the actual work result of the worker match even if the actual work result of the worker does not match the ideal work result. In this case, evaluation of the work result is not displayed as a guide image. Alternatively, an image, voice, or the like may be displayed so that the worker can recognize that the work has been achieved.

The determination of whether or not the ideal work result of the worker and the actual work result of the worker match can be performed by causing the information processing apparatus 1 to learn the work pattern of the worker in advance using the work history of the worker and the like.

Part (a) of FIG. 15 shows the ideal work result 50. Part (b) of FIG. 15 shows the actual work result 13 performed by a worker and shows the outline of the heart that is the ideal work result 50 of the information processing system 100 by a broken line. Part (c) of FIG. 15 shows an ideal work result 54 after changing the ideal work result.

As shown in Parts (a) and (b) of FIG. 15, even if the actual work result 13 performed by the worker does not match the ideal work result 50 of the information processing system 100, the ideal work result may be changed to the ideal work result 54 of the information processing system 100 by, for example, changing the size of the ideal work result as shown in Part (c) of FIG. 15 in the case where the ideal work result of the worker and the actual work result of the worker match.

### Other Embodiments

Although an embodiment of the present invention has been described above, the present invention is not limited to only the above-mentioned embodiment, and it goes without saying that various modifications can be made without departing from the essence of the present invention.

Although other embodiments will be described below, configurations similar to those in the above-mentioned embodiment will be denoted by similar reference symbols and description thereof will be omitted in some cases.

Although AR glasses are used as an example of the display device 71 that displays a guide image in the above-mentioned embodiment, the present technology is not limited thereto. Other application examples will be described below.

The display device 71 may be a head-mounted display that includes a non-transmissive display. The head-mounted display is a wearable computer worn on the head of the worker W.

In the above-mentioned AR glasses, scenery in which a guide image has been superimposed on the field-of-view area of a worker including a work area that is a real object in the real world is presented to the worker.

Meanwhile, in the head-mounted display, a display image in which the guide image 24 has been superimposed on an actual image including the work area corresponding to the field-of-view area of the worker in the real world, which is acquired by a camera, can be presented to the worker. As a result, it looks as if the guide image is superimposed and displayed on the work area in the real world in the field-of-view area for the worker wearing the head-mounted display, and it can be recognized as a form in which the work area and the display area of the guide image are integrated. As a result, the worker can realistically simulate the ideal work result, for example. Further, it is possible to perform drawing so as to trace the guide image displayed on the work area 11 in the real world, which allows the worker to perform more accurate drawing.

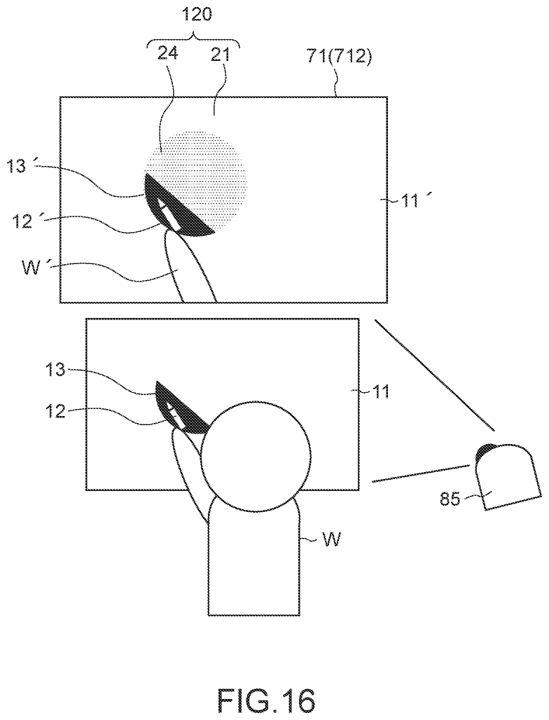

The display device 71 may be a monitor. FIG. 16 shows an example of using a monitor 712 to display a guide image. In the example shown in FIG. 16, the worker W is performing filling work on the work area 11 using the operating body 12. The camera 85 is installed so that images of the worker W, the work area 11, and the operating body 12 can be acquired, for example. In FIG. 16, the work area, the operating body, the worker, and the actual work result displayed on the monitor 712 are respectively denoted by reference symbols 11′, 12′, W′, and 13′.

As shown in FIG. 16, the monitor 712 that is the display device 71 is located at a position different from the work area 11 in the real world, e.g., above the work area 11. A display image 120 in which the guide image 24 has been superimposed on an actual image 21 of real objects such as the work area 11′ in the real world, the operating body 12′, the hand of the worker W′, and the actual work result 13′, which is acquired by the camera 85, is displayed on the monitor 712.

In the example shown in FIG. 16, on the monitor 712, the portion of the work area 11 corresponding to the position of the operating body 12 is enlarged to be larger than the size of the ideal work result performed on the work area 11 in the real world and displayed. In accordance with the work situation of the worker, the guide image having a size different from the size of the ideal work result may be displayed on the monitor 712 or the guide image having a size equivalent to the size of the ideal work result may be displayed on the monitor 712. Further, in accordance with the work situation of the worker, the position of the guide image 24 in the work area 11′ may be displayed to be the same as or different from the position of the guide image 24 in the entire work area 11 in the real world, in the display image 120 displayed on the monitor 712. For example, even in the case where the work target portion in the work area 11 in the real world is located on the left side of the work area 11, the guide image corresponding to the work target portion may be displayed to be located in the center of the display image 120, in the display image displayed on the monitor 712. The worker W can perform work while seeing the display image 120 displayed on the monitor 712. The position of the monitor 712 may be fixed or movable.

In the case where the monitor 712 generates a display image in which a guide image has been superimposed on an actual image, for example, the size of the basic guide image may be appropriately set in accordance with the display unit of the monitor 712. For example, the basic guide image may have a size equivalent to the size of the ideal work result in the work area 11 in the real world, or the basic guide image may have an enlarged or reduced size. Then, the modification in the modified guide image may include a change in size such as enlargement and reduction of the basic guide image, in addition to the modification described above.

Although an example in which the display image 120 is displayed on the monitor 712 has been given here, the display image 120 may be projected on a screen, a wall, or the like by a project that is the display device 71 and displayed.

In the information processing apparatus 1, the display image 120 is generated by the display generation unit 43 and transmitted to the display device 71.

The display generation unit 43 generates the display image 120 such that the guide image 24 that is a virtual object is located between the operating body 12 and the work area 11 as shown in FIG. 3 using the position information of the work area 11 and the position information of the operating body 12. That is, the display image 120 in which the work area 11, the guide image 24, and the operating body 12 are located in this order from the back side to the front side as seen from the worker is generated.

Note that the display image 120 can be generated such that a real object located in front of the guide image as seen from the worker is not displayed. In this case, the display image 120 may be generated by adding an auxiliary image indicating the tip position of the operating body such that the worker can intuitively grasp where the operating body is located on the work area, or the display image 120 may be generated such that the operating body is displayed without being erased.

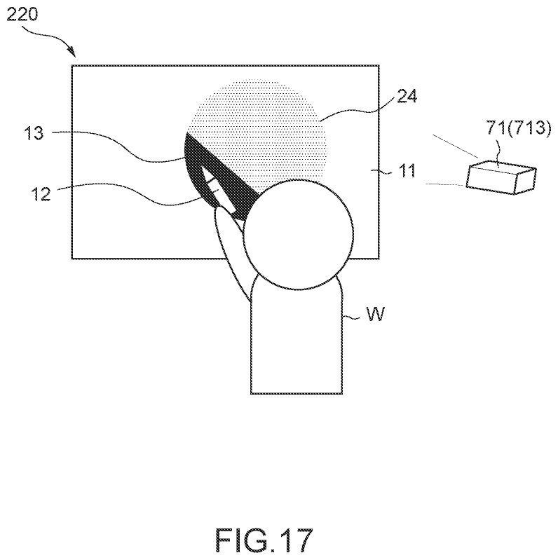

Further, as shown in FIG. 17, the guide image 24 may be projected and displayed on the work area 11 in the real world by a projector 713 that is the display device 71.

In this case, although the guide image 24 is superimposed and projected on a real object such as the operating body 12 in some cases, it is possible to smoothly perform work by displaying the guide image whose display form changes depending on the work situation of the worker as in the above-mentioned embodiment.

As described above, the present technology can be applied to generation of a guide image to be superimposed on a work area in the real world or an actual image of the work area and displayed. Then, by generating a guide image using at least one of the position information of the work area in the real world and the position information of the operating body or the work state information in the work area, for example, a guide image suitable for the work situation is generated as in the embodiment described using AR glasses as an example. The worker can perform work easily and quickly by referring to the guide image.

Further, although an example in which work is performed on a canvas or paper as a work area with a writing implement such as a pen as an operating body has been given in the above-mentioned embodiment, the present technology is not limited thereto. For example, the present technology can be applied to makeup work, painting work using a brush, or the like, and it is possible to perform work assistance of the worker.

In the case of makeup work, the work area is the worker's face. The operating body is a brush, an applicator, a puff, the worker's finger, or the like. For example, a display image in which a guide image for assisting work of the worker has been superimposed on the actual image of the face that is the work area in the real world, which is acquired by a camera, is displayed on a monitor. The worker can apply makeup while referring to the display image displayed on the monitor.

Further, the output method may be a smart mirror. For example, a guide image is superimposed on the worker's face projected on the smart mirror. As an example, the guide image is an image indicating the application range and color of a blush. The worker can apply the blush so as to trace the guide image.

As an example of work assistance in the makeup work, foundation application work will be described as an example. The foundation often leaves unapplied portions that the worker is unaware of, and uneven makeup tends to occur. A guide image in which the unapplied portions are highlighted is displayed after work and the work result is evaluated, which allows the worker to grasp the unapplied portions. The worker can reapply the foundation by referring to the guide image in which the unapplied portions are highlighted, which prevents the uneven makeup from occurring.

Further, since the skin condition differs from person to person and from day to day, the skin condition is checked before makeup work and the makeup method is changed accordingly in some cases. In the present technology, for example, since the guide image can be erased in accordance with the work situation of the worker, it is possible to check the condition of the skin that is the work area without being obstructed by the display of the guide image. As a result, it is possible to change the makeup method depending on the condition of the skin.

In this way, the worker can perform makeup work easily and quickly by referring to a guide image.

In the case of painting work, the work area is, for example, a wall. The operating body is a brush or the like. A guide image can be provided to the worker using the above-mentioned various display devices. The worker can perform painting work easily and quickly by referring to the guide image.

Further, an example in which the modified guide image 242 including the dot-like auxiliary image 26 indicating the tip position of the operating body 12 is displayed has been described above with reference to Part (c) of FIG. 8. The auxiliary image indicating the tip position of the operating body does not necessarily need to have a dotted shape, and the shape may be changed depending on the shape of the tip of the operating body to optimize the display. For example, in the case where the operating body is a brush with a long brush tip, the auxiliary image may have an elliptical shape reflecting the change in the shape of the tip of the operating body. As a result, the worker can intuitively grasp the contact range between the work area and the operating body and check whether the handling of the operating body by himself/herself is appropriate, and the like.

Further, in the case where the operating body and the work area cannot be detected, a guide image according to the situation may be displayed. For example, the work trace on the work area in the real world is stored in the storage unit as a work history. In the case where it is determined that there is a current work trace at a position different from that of the stored one, it may be recognized that the work surface has shifted, the display of the guide image may be erased, and the whole may be detected again.

Further, a guide image may be generated in consideration of the physical characteristics such as height and eyesight of the worker. A guide image in which the area and color of the user interface to be displayed has been changed may be generated on the basis of the height and eyesight of the worker.

For example, in the case where the work area is wide, in accordance with the worker, the entire work area is not a range in which he/she can perform work in some cases. In such a case, a guide image corresponding to the estimated workable range may be displayed. The workable range is part of the work area. The reachable range of the worker, i.e., the workable range, is estimated on the basis of the height of the worker, and a guide image in the range is displayed. Further, a workable range for the worker may be estimated on the basis of the sight of the worker, and a guide image corresponding to the range may be displayed. Further, characters may be used to compensate for the difficulty in seeing the color of a real object.

Further, a guide image may be generated in consideration of the features of work of a worker. The features of the work of the worker may be detected on the basis of a work result, and a guide image according to the features may be generated.

For example, the outline of the guide image may be highlighted for a worker who boldly performs work, e.g., performs drawing protruding from the guide image.

For example, a guide image that prompts a worker who boldly performs work, e.g., performs drawing protruding from the guide image, to start work by filling a wide area may be displayed.

Further, a guide image may be generated by changing the content of a guide image itself depending on the actual work result of a worker. For example, when the worker has drawn a line that is too long than the guide image, the guide image may be changed to the design content according to the line that is too long instead of suggesting that the worker erase the line.

Further, in the case where the display form of the guide image is not the form desired by the worker, feedback may be provided so that the guide image can be changed. For example, in the case where the work area that the worker wants to see is blocked and obstructed by the guide image, the guide image may be erased by performing an action by the worker as if it is erased with an eraser.

Further, although an example in which a display device such as a projector and AR glasses is used alone has been given in the above description, an information processing system that uses a plurality of display devices that displays a guide image may be provided.

For example, the information processing system may use a projector and AR glasses. In AR glasses that perform self-position estimation, the true position and the estimated position deviate in some cases as the usage time elapses. This deviation can be corrected using an external camera separate from the AR glasses. While this correction is performed, it is possible to switch to guide image display by a projector without displaying a guide image by the AR glasses. As a result, the worker can continue to perform work while being assisted by the guide image.

By including a plurality of display devices as described above, it is possible to use one display device to compensate for processing or the like that cannot be completed by the other display device. As a result, it is possible to continue the assistance for the worker.

Further, although an example in which feedback of a work result is visually displayed mainly as a guide image has been given in the above-mentioned embodiment, voice display or haptic sensation display may be used in addition to the visual display.

For example, the display generation unit 43 may generate an audio signal for audibly displaying that the work result is good. The display generation unit 43 may generate a vibration signal as a display signal in order to display a warning that drawing has been performed protruding from the guide image with a haptic sensation. For example, haptic sensation display is performed on the worker by mounting a compact motor for a vibrator on the operating body or the like or attaching the small motor to the worker's wrist and causing the compact motor to vibrate on the basis of the generated vibration signal.

Further, characters may be displayed as an auxiliary image on the basic guide image to give feedback of the work result.

Further, although an example in which a two-dimensional guide image is displayed in a two-dimensional work area such as paper and canvas has been given in the above-mentioned embodiment, the present technology is not limited thereto. For example, the present technology can be applied also to model creation work or the like, and a three-dimensional guide image may be displayed.

It should be noted that the present technology may also take the following configurations.

(1) An information processing apparatus, including:
a processing unit that generates, by using at least one of position information of a work area in a real world and position information of an operating body that performs work on the work area by an operation of a worker or work state information in the work area, a guide image for assisting work of the worker in the work area, the guide image being superimposed and displayed on the work area in the real world or an actual image of the work area.
   (2) The information processing apparatus according to (1) above, in which
the processing unit generates the guide image in further consideration of at least one of state information of the operating body or state information of the worker.
   (3) The information processing apparatus according to (1) or (2) above, in which
the processing unit estimates, by using at least one of the position information of the work area and the position information of the operating body or the work state information in the work area, a work situation of the worker and changes a display form of the guide image in accordance with a result of the estimation.
   (4) The information processing apparatus according to (3) above, in which
The display form of the guide image includes display of a basic guide image indicating an ideal work result to be performed on the work area, display of a modified guide image obtained by modifying the basic guide image, or non-display of the basic guide image and the modified guide image.
   (5) The information processing apparatus according to (4) above, in which
the modifying includes at least one of a color change, a transparency change, a line width or line style change, an addition of an auxiliary image, a change to frame line display indicating an outline of the basic guide image, a change to outline display of the basic guide image, a resolution change, or highlighting.
   (6) The information processing apparatus according to any one of (3) to (5) above, in which
the processing unit estimates whether the work situation of the worker is before work, during work, or after work and generates the guide image in accordance with a result of the estimation.
   (7) The information processing apparatus according to (6) above, in which
the processing unit further subdivides and estimates the work situation of the worker by using at least one of the position information of the work area and the position information of the operating body, the work state information in the work area, state information of the operating body, or state information of the worker, and generates the guide image in accordance with a result of the estimation.
   (8) The information processing apparatus according to (6) above, in which
the processing unit generates, upon estimating that the work situation of the worker is after work, a guide image reflecting evaluation of an actual work result by the worker.
   (9) The information processing apparatus according to (8) above, in which
the guide image reflecting evaluation of the actual work result is an image in which a different portion between an ideal work result and the actual work result by the worker is highlighted.
   (10) The information processing apparatus according to (9) above, in which
the processing unit generates, in a case where the different portion is an insufficient portion where work by the worker is insufficient for the ideal work result and work is performed on the insufficient portion by the operating body, a display signal for assisting the worker to achieve the ideal work result.
   (11) The information processing apparatus according to (6) above, in which
the processing unit generates, in a case where the work situation of the worker is estimated to be after work and a result of work performed by the worker and an ideal work result match, a display signal for displaying information indicating that the guide image is to be not displayed or the results match.
   (12) The information processing apparatus according to (6) above, in which
the processing unit changes, in a case where the work situation of the worker is estimated to be after work and a result of work performed by the worker and an ideal work result do not match, the ideal work result on the basis of a work pattern of the worker or on the basis of content of the result of work performed by the worker.
   (13) The information processing apparatus according to any one of (1) to (12) above, in which
the operating body is a part of a body of the worker or an object that can be held by the worker.
   (14) An information processing method, including:
acquiring position information of a work area in a real world, position information of an operating body that performs work on the work area by an operation of a worker, and work state information in the work area; and
generating, by using at least one of the position information of the work area and the position information of the operating body or the work state information in the work area, a guide image for assisting work of the worker in the work area, the guide image being superimposed and displayed on the work area in the real world or an actual image of the work area.
   (15) A program that causes an information processing apparatus to execute the steps of:
acquiring position information of a work area in a real world, position information of an operating body that performs work on the work area by an operation of a worker, and work state information in the work area; and
generating, by using at least one of the position information of the work area and the position information of the operating body or the work state information in the work area, a guide image for assisting work of the worker in the work area, the guide image being superimposed and displayed on the work area in the real world or an actual image of the work area.

### REFERENCE SIGNS LIST

1 information processing apparatus
4 processing unit
11 work area
12 operating body
13 actual work result by a worker
24 guide image
241 basic guide image
242 alternative guide image
W worker

1. An information processing apparatus, comprising:
a processing unit that generates, by using at least one of position information of a work area in a real world and position information of an operating body that performs work on the work area by an operation of a worker or work state information in the work area, a guide image for assisting work of the worker in the work area, the guide image being superimposed and displayed on the work area in the real world or an actual image of the work area.

2. The information processing apparatus according to claim 1, wherein
the processing unit generates the guide image in further consideration of at least one of state information of the operating body or state information of the worker.

3. The information processing apparatus according to claim 1, wherein
the processing unit estimates, by using at least one of the position information of the work area and the position information of the operating body or the work state information in the work area, a work situation of the worker and changes a display form of the guide image in accordance with a result of the estimation.

4. The information processing apparatus according to claim 3, wherein
The display form of the guide image includes display of a basic guide image indicating an ideal work result to be performed on the work area, display of a modified guide image obtained by modifying the basic guide image, or non-display of the basic guide image and the modified guide image.

5. The information processing apparatus according to claim 4, wherein
the modifying includes at least one of a color change, a transparency change, a line width or line style change, an addition of an auxiliary image, a change to frame line display indicating an outline of the basic guide image, a change to outline display of the basic guide image, a resolution change, or highlighting.

6. The information processing apparatus according to claim 3, wherein
the processing unit estimates whether the work situation of the worker is before work, during work, or after work and generates the guide image in accordance with a result of the estimation.

7. The information processing apparatus according to claim 6, wherein
the processing unit further subdivides and estimates the work situation of the worker by using at least one of the position information of the work area and the position information of the operating body, the work state information in the work area, state information of the operating body, or state information of the worker, and generates the guide image in accordance with a result of the estimation.

8. The information processing apparatus according to claim 6, wherein
the processing unit generates, upon estimating that the work situation of the worker is after work, a guide image reflecting evaluation of an actual work result by the worker.

9. The information processing apparatus according to claim 8, wherein
the guide image reflecting evaluation of the actual work result is an image in which a different portion between an ideal work result and the actual work result by the worker is highlighted.

10. The information processing apparatus according to claim 9, wherein
the processing unit generates, in a case where the different portion is an insufficient portion where work by the worker is insufficient for the ideal work result and work is performed on the insufficient portion by the operating body, a display signal for assisting the worker to achieve the ideal work result.

11. The information processing apparatus according to claim 6, wherein
the processing unit generates, in a case where the work situation of the worker is estimated to be after work and a result of work performed by the worker and an ideal work result match, a display signal for displaying information indicating that the guide image is to be not displayed or the results match.

12. The information processing apparatus according to claim 6, wherein
the processing unit changes, in a case where the work situation of the worker is estimated to be after work and a result of work performed by the worker and an ideal work result do not match, the ideal work result on a basis of a work pattern of the worker or on a basis of content of the result of work performed by the worker.

13. The information processing apparatus according to claim 1, wherein
the operating body is a part of a body of the worker or an object that can be held by the worker.

14. An information processing method, comprising:
acquiring position information of a work area in a real world, position information of an operating body that performs work on the work area by an operation of a worker, and work state information in the work area; and
generating, by using at least one of the position information of the work area and the position information of the operating body or the work state information in the work area, a guide image for assisting work of the worker in the work area, the guide image being superimposed and displayed on the work area in the real world or an actual image of the work area.

15. A program that causes an information processing apparatus to execute the steps of:
acquiring position information of a work area in a real world, position information of an operating body that performs work on the work area by an operation of a worker, and work state information in the work area; and
generating, by using at least one of the position information of the work area and the position information of the operating body or the work state information in the work area, a guide image for assisting work of the worker in the work area, the guide image being superimposed and displayed on the work area in the real world or an actual image of the work area.
